(19) United States
(12) Patent Application Publication
(10) Pub. No.: US 2013/0324337 A1
(43) Pub. Date: Dec. 5, 2013

(54) HYDRAULIC TENSIONER

(71) Applicant: TSUBAKIMOTO CHAIN CO., Osaka (JP)

(72) Inventors: Osamu Yoshida, Osaka (JP); Yuji Kurematsu, Osaka (JP)

(73) Assignee: TSUBAKIMOTO CHAIN CO., Osaka (JP)

(21) Appl. No.: 13/898,976

(22) Filed: May 21, 2013

(30) Foreign Application Priority Data
Jun. 4, 2012 (JP) 2012-127248

(51) Int. Cl. F16H 7/08

(52) U.S. Cl. CPC F16H 7/08
USPC 474/110

(57) ABSTRACT

In a hydraulic tensioner for maintaining tension in a traveling transmission medium in an engine, oil is delivered to an expansible chamber formed by a tensioner housing and a plunger through a reserve chamber composed of an entrance reserve chamber into which oil flows from an oil supply and a supply reserve chamber from which oil flows to the expansible chamber. A partition between the entrance and supply reserve chambers establishes a communication passage that ensures an amount of oil in the supply reserve chamber sufficient to make up the loss of oil due to leakage from the expansible chamber during a long interval while engine is inoperative, and additional leakage from the expansible chamber due to reciprocating movement of the plunger when the engine is started.

### CROSS-REFERENCE TO RELATED APPLICATIONS

Japanese Patent Application No. 2012-127248, filed on Jul. 4, 2012, on which this application claims priority, is hereby incorporated by reference.

### FIELD OF THE INVENTION

This invention relates to a hydraulic tensioner configured to apply tension to an endless flexible traveling transmission medium, for example the timing chain of an internal combustion engine.

### BACKGROUND OF THE INVENTION

A conventional hydraulic tensioner provided in a chain transmission driven by an engine includes an oil chamber, which is formed by the housing of the tensioner and a plunger arranged to slide in, and protrude from, a plunger-accommodating hole in the housing. Oil from an oil pump that operates and stops as the engine operates and stops, is fed into the oil chamber through an oil supply passage and a check valve provided in the tensioner housing, and serves as a hydraulic fluid, exerting a force urging the plunger in an advancing direction, and damping the movement of the plunger by leaking through a small gap between the plunger and the wall of the plunger-accommodating hole in the housing. When the tension in the chain increases, the plunger is pushed in a retracting, or “setback,” direction, and the leakage of oil from the oil chamber that occurs as the plunger is pushed back controls the speed of retraction of the plunger and attenuates flapping and vibration of the chain, reducing noise.

If the engine is inoperative for a long time, the engine oil pump is stopped and no oil is supplied to the oil chamber of the tensioner. Then, because of the necessary leakage of oil through the gap between the plunger and the wall of the plunger-accommodating hole, the oil within the oil chamber becomes depleted, and replaced by air. As a result, when the engine is started after a long interval in which it is not operated, flapping of the chain will occur until the oil in the oil chamber is replenished by the oil pump.

To suppress flapping of the chain caused by insufficient oil within the oil chamber on starting an engine that has been out of operation for a long time, it is known to provide a reserve oil chamber in a passage that through which oil flows to the tensioner, as disclosed in Japanese Patent No. 3141740, dated Feb. 4, 1997.

It is possible for air within the oil chamber to pass into the reserve chamber through a check valve, or into the reserve chamber through an oil supply passage, depending on the oil level in the oil chamber of the tensioner.

When a partition that divides the reserve chamber extends between the reserve chamber inlet and the reserve chamber outlet to a position below the level of the inlet and outlet, the oil level around the outlet can be lowered, and the supply of oil from the reserve chamber to the oil supply passage of the tensioner can cease due to an increase in pressure around the outlet resulting from infiltration of air from the oil chamber to the reserve chamber through the outlet. As a result the ability of the tensioner to suppress flapping of the chain is impaired.

Depending on the position in which the tensioner mounted on an engine, it can also be difficult to arrange the inlet below the level of the outlet in order to ensure that the required amount of the oil is supplied from the reserve chamber to the oil chamber. The need to arrange the inlet below the level of the outlet imposes limitations on the configuration of the tensioner and on the manner in which it is mounted on the engine.

If a pressure difference sufficient to open the tensioner check valve is not generated by advancing movement of the plunger on starting the engine after a long inoperative interval, oil cannot flow efficiently from the reserve chamber into the oil chamber. This insufficient pressure difference is another factor that can result in flapping of the chain.

Accordingly, there is a need for a hydraulic tensioner that more effectively suppresses flapping of a transmission medium, reduces the noise generated by flapping on starting an engine, and provides greater freedom in the disposition of the tensioner with respect to an engine on which it is mounted.

### SUMMARY OF THE INVENTION

The tensioner according to the invention is a tensioner for applying tension to an endless, flexible, traveling transmission medium driven by an engine. The transmission medium can be, for example, the timing chain in an internal combustion engine. The tensioner comprises a housing adapted for attachment to an engine and provided with an oil supply passage and a plunger-accommodating hole, and a plunger protruding from the plunger-accommodating hole of the housing and slidable therein in an advancing and retracting direction. The plunger and housing form an expansible oil chamber.

The tensioner includes a reserve chamber. The reserve chamber can be, but is not necessarily, formed in the tensioner housing. Alternatively, for example, the reserve chamber can be formed in the wall of an engine block to which the tensioner is attached, or in part by the engine block wall and in part by the tensioner housing. The reserve chamber supplies oil from an oil supply source to the oil supply passage of the tensioner housing when the engine is operating. The plunger is biased in its advancing direction by a spring or other biasing means. A check valve permit oil to flow from 1 the oil supply passage to the expansible oil chamber, but limits reverse flow of oil from the expansible oil chamber to the oil supply passage.

The reserve chamber is provided with an inlet for flow of oil from the oil supply source to the reserve chamber, and an outlet for flow of oil from the reserve chamber to said oil supply passage. The reserve chamber is divided by a partition wall into an entrance reserve chamber, into which the oil flows from the inlet, and a supply reserve chamber from which oil flows through the outlet. The partition wall forms a communication passage for flow of oil from the entrance reserve chamber to the supply reserve chamber, and the communication passage is located above the outlet.

Upon starting the engine, even before oil is supplied to the tensioner by the engine oil pump, oil in the reserve chamber is supplied to the expansible oil chamber formed by the tensioner housing and the plunger. The oil supplied from the reserve chamber suppresses flapping of the transmission medium and reduces noise.

When the engine is stopped, the engine oil pump is inoperative, and the supply of oil to reserve chamber is cut off. The amount of oil that can be supplied to the oil chamber of the tensioner from the reserve chamber before flow of oil to the reserve chamber is reestablished depends on the vertical distance from the communication passage to the outlet of the supply reserve chamber. Even if air from the expansible oil chamber of the tensioner infiltrates into the supply reserve chamber through its outlet while the supply of the oil to the reserve chamber is cut off, the air gathers above the outlet. Accordingly, the oil amount of oil that can be supplied to the tensioner from the supply reserve chamber is not affected by the infiltrated air.

When the pressure of the oil at the inlet drops after the supply of oil to the reserve chamber is stopped, the oil level in the entrance reserve chamber can drop. However, the drop of pressure will not cause a drop of the oil level in the supply reserve chamber, and the outlet of the supply reserve chamber, which is located below the communication passage, remains below the oil level in the supply reserve chamber. Therefore, the oil reserved in the supply reserve chamber is steadily supplied to the oil supply passage. Accordingly, flapping of the transmission medium and resulting flapping noises that occur on start-up of the engine are suppressed.

Because the reserve oil supply is preset based on the vertical spacing of the communication passage and the outlet, the relationship between the positions of the inlet and the outlet of the reserve chamber is not critical and the designer is therefore afforded a large degree of freedom in determining the position of the outlet relative to the inlet, and also in the disposition of the tensioner with respect to the engine.

According to a second aspect of the invention, the partition wall establishes an oil level in the supply reserve chamber and an oil level in the entry reserve chamber, and prevents flow of oil from one of these two reserve chambers to the other except through the communication passage.

Here again the reserve oil supply depends on the positions of communication passage and the outlet, and is unaffected by the positional relationship of the inlet and the outlet, so that the amount of reserve oil available can be predetermined while the designer is afforded freedom in determining position of the inlet relative to the outlet, and the disposition of the tensioner on the engine

According to a third aspect of the invention, the inlet is separated from, and located above the lowest part of the entrance reserve chamber. Therefore a quantity of oil is reserved below the inlet in the entrance reserve chamber. This arrangement provides for rapid reestablishment of oil flow from the entrance reserve chamber to the supply reserve chamber through the communication passage when the supply of oil to the reserve chamber is restarted, reducing the time lag in supplying oil from the oil supply source to the oil chamber on restarting of the engine. Thus, it is possible to shorten the starting transient and to improve the suppression of flapping.

According to a fourth aspect of the invention, a minimum value A of a supply reserved volume of oil in the reserve chamber is related to the volume occupied by oil remaining within the oil chamber after oil has not been supplied from the oil supply source for a long time interval, and to the amount of oil leakage from the oil chamber caused by reciprocating movement of the plunger on starting said engine after the long time interval, by the formula

A=Vc−Vr+Qs

where:
Vc is a reference volume of the oil chamber larger than the volume of the oil chamber when the long time interval has elapsed;
Vr is the volume of oil remaining in said oil chamber when said long time interval has elapsed; and
Qs is the amount of the oil leakage from the oil chamber caused by the reciprocating movement of the plunger on starting the engine after the elapse of the long time interval.

The volume of the air space in the expansible oil chamber of the tensioner after a long inoperative time interval is an index of an insufficient amount of the oil within the oil chamber. The reserve supply chamber ensures that an amount of oil is available not only to replenishes the oil that leaks from the oil chamber due to reciprocating movement of the plunger caused by fluctuations in chain tension on engine start-up, but also and, in addition, an amount that corresponds to the calculated air space volume based on a reference volume which is greater than the volume of the oil chamber when the tensioner has been inoperative for a long time.

Here again, the starting transient of the tensioner is shortened, and improved suppression of flapping of the transmission medium and resultant noise is achieved.

According to a fifth aspect of the invention, the volume of the air space within the oil chamber after oil has not been supplied from the oil supply source for a long time interval is such that the check valve is opened by a drop of pressure in the air space when the plunger advances by a predetermined starting stroke on starting the engine after the elapse said long time interval.

With this arrangement, because the check valve opens due to the drop of pressure of the air space when the plunger advances on engine start-up after a long inoperative interval, oil reserved in the supply reserve chamber is fed efficiently to the oil chamber through the outlet, the oil supply passage and the check valve. Again, this feature shortens the starting transient and improves the suppression of flapping of the transmission medium and resultant noise.

### BRIEF DESCRIPTION OF THE DRAWINGS

FIG. 1 is a schematic front elevational view of an engine timing transmission incorporating a tensioner according to the invention;

FIG. 2 is a sectional view taken on a section plane II-II in FIG. 1;

FIG. 3 is a sectional view taken on a section plane in FIG. 2;

FIG. 4 is a fragmentary sectional view taken on section plane IV-IV in FIG. 2;

FIG. 5 is a sectional view corresponding to FIG. 3 and illustrating the condition of the tensioner after the engine has been inoperative for an extended time and a large volume of air has accumulated within the oil chamber; and

FIG. 6 is a fragmentary sectional view corresponding to FIG. 4 and showing another embodiment of the invention.

### DESCRIPTION OF THE EMBODIMENTS

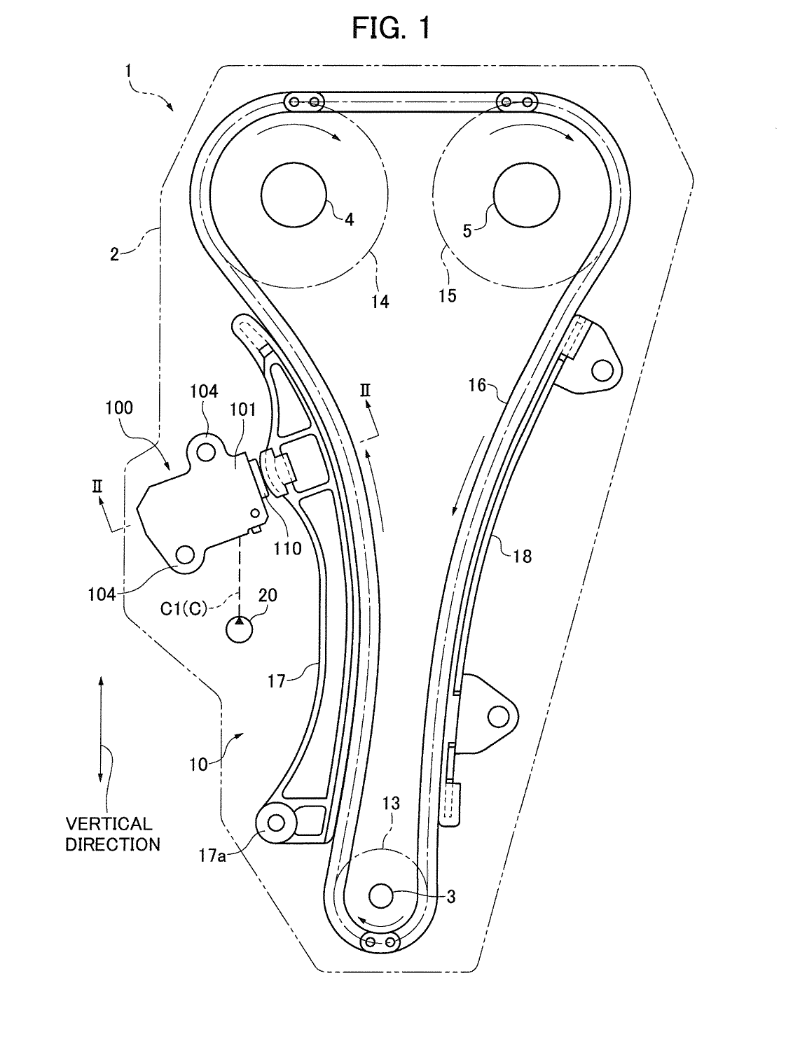

As shown in FIG. 1, a tensioner 100 is incorporated into a timing drive 10 of an internal combustion engine 1.

The timing drive 10 includes a driving sprocket 13 rotated by an engine crankshaft 3, and a pair of driven sprockets 14 and 15 on valve-operating camshafts 4 and 5 respectively. An endless chain 16 is driven by sprocket 13, and in driving relationship with sprockets 14 and 15.

The timing drive includes a movable guide urged by tensioner 100 against a span of chain 16 that travels from crankshaft sprocket 13 to camshaft sprocket 14, and a fixed guide 18 in sliding relationship with a span of the chain that travels from camshaft sprocket 15 toward crankshaft sprocket 13. The movable guide has a part 17a that is pivoted on a shaft fixed to the engine block. The fixed guide 18 is mounted in fixed relation to the engine block.

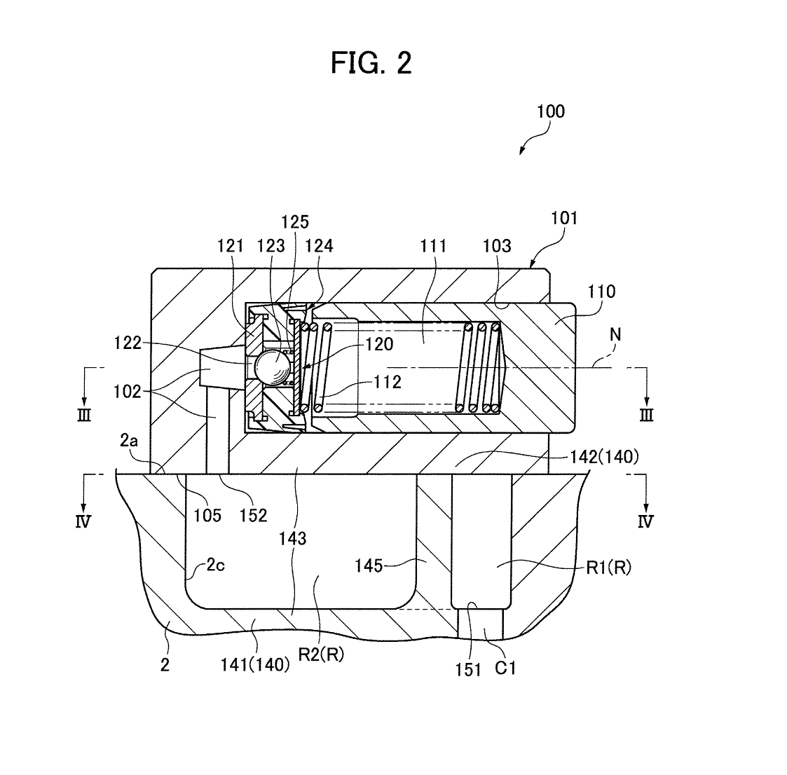

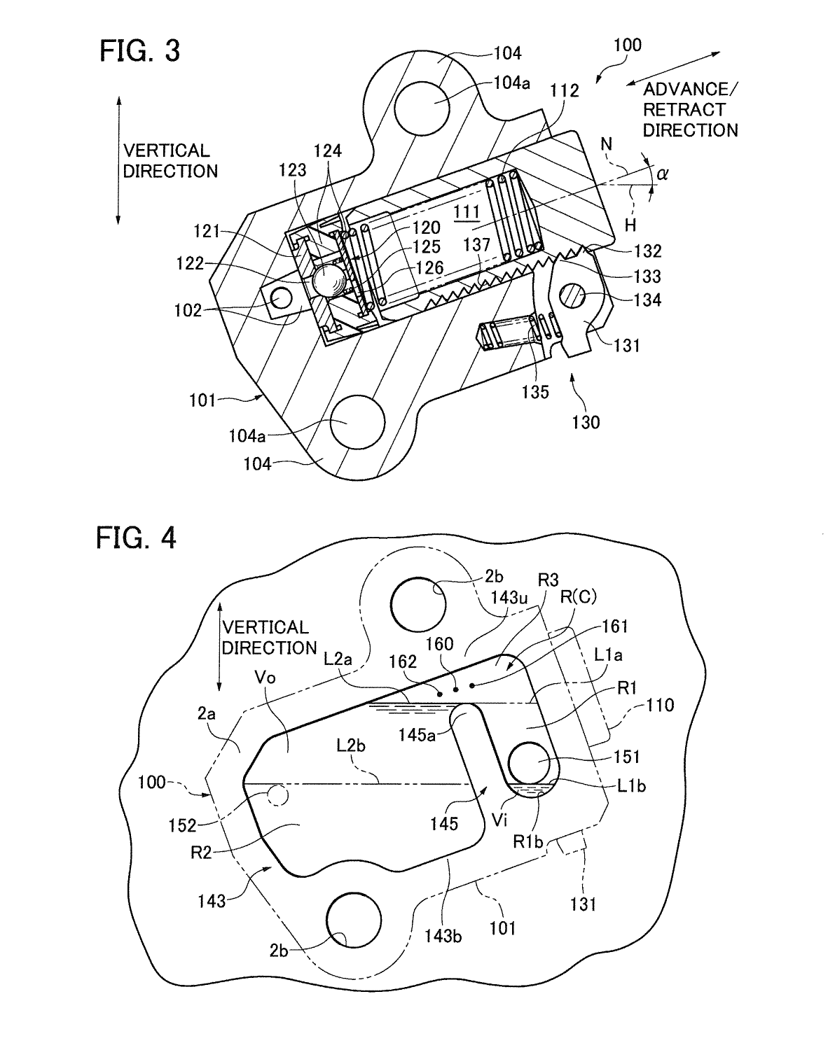

As shown mainly in FIGS. 2 and 3, and partly in FIG. 1, the tensioner 100 includes a housing 101 provided with an oil supply passage 102 and a plunger-accommodating hole 103, a plunger 110 protruding from the plunger-accommodating hole 103 and slidable therein so that it can advance and retract along an advancing and retracting direction. The plunger, which is hollow, and the plunger-accommodating hole cooperate to form an oil chamber 111 and a biasing spring 112 disposed within the oil chamber 111 urges the plunger 110 in its advancing direction.

A check valve 120 permits oil, supplied by an oil pump 20 (shown schematically in FIG. 1), through an oil supply passage 102 to the oil chamber 111, but limits reverse flow of oil from the oil chamber 111 to the oil supply passage 102. A ratchet mechanism 130 (FIG. 3) restricts retracting movement of the plunger 110 while permitting advancing movement. The biasing spring 112 and the oil within the oil chamber 111 cooperate to bias the plunger 110 in the advancing direction to apply tension to the chain 16.

The advancing and retracting direction is substantially parallel to a central axis N of the plunger-accommodating hole 103, which substantially coincides with the axis of the plunger 110 when the plunger is in hole 103.

The term “substantially,” when used herein as a modifier, is intended to signify that the word or expression so modified encompasses a range in which there is no significant difference insofar as operation and effect are concerned.

The housing 101 has a pair of mounting flanges 104 for attachment of the tensioner 100 to the engine block 2, and a surface 105 (FIG. 2) that is in oil-tight facing engagement with an engine block surface 2a. It is also possible to provide a seal formed by a gasket, an O-ring, a liquid gasket material or the like, around the circumference of a reserve chamber R formed in the engine block.

The housing 101 is removably attached to the engine block 2 by bolts (not shown) which extend through holes 104a (FIG. 3) in the mounting flanges 104 and are threaded into holes 2b in the engine block 2.

The tensioner 100 is fixed to the engine block 2 so that axis N of the plunger-accommodating hole, i.e. the direction the advance and retraction of the plunger forms an angle α with a horizontal direction H, as shown in FIG. 3, when the automobile in which the engine is mounted is on a horizontal road surface. The oil supply passage 102 of the tensioner housing is connected to an oil pump 20 of the engine lubrication system through an oil passage C shown schematically in FIG. 1. The oil pump 20 operates when the engine is running, but stops when the engine is stopped.

The oil passage C includes a reserve chamber R (FIG. 2), and an entrance oil passage C1 that connects the oil pump 20 with the reserve chamber R.

As shown in FIGS. 2 and 3, the oil supply passage 102 provides for flow of oil from the reserve chamber R to the check valve 120. The check valve 120 includes a valve seat 121 provided with a valve oil passage 122 that communicates with the oil supply passage 102, a check ball 123, that opens and closes the valve oil passage 122, a retainer 124 that allows the check ball to separate from, and seat on, the valve seat 121 but limits movement of the check ball 123, and a valve spring 125 that presses the check ball 123 against the valve seat 121.

Oil flowing through the check valve 120 from the oil supply passage 102 flows into the oil chamber 111 through an opening 125 of the retainer 124 when the check valve is open, i.e. when the check ball is away from the valve seat. However the check valve limits flow of oil from the oil chamber 111 to the oil supply passage 102 when check ball is positioned against the valve seat.

As shown in FIGS. 3, the ratchet mechanism 130 includes a ratchet pawl 131 pivoted on a supporting shaft 134, and a rack of teeth 137 on the plunger 110. The pawl 131 has a pair of ratchet claws 132 and 133 that are engageable with rack teeth 137. A spring 135 biases the ratchet pawl 131, in a direction such that the claws 132 and 133 are pressed into engagement with the rack teeth 137.

The ratchet mechanism 130 restricts retracting movement of plunger 110 by the engagement of the first ratchet claw 132 with the rack teeth 137, and permits the plunger 110 to advance in accordance with the condition of engagement of the second ratchet claw 133 with the rack teeth 137. The ratchet mechanism 130 has a backlash corresponding to the stroke of the plunger from a position in which the second ratchet claw 133 disengages from the rack teeth 137 to a position in which the first ratchet claw 132 is fully engaged with the rack teeth.

As shown in FIGS. 2 and 3, the reserve chamber R has an inlet 151 through which oil from the oil pump 20 flows into the reserve chamber R from an entrance oil passage C1. The reserve chamber R has an outlet 152 through which oil flows from the reserve chamber R to the oil supply passage 102. Although, as seen in FIG. 4, the inlet 151 is located above the level of the outlet 152 in the embodiment shown, the inlet 151 may be located on the same level with the outlet 152, or below the level of the outlet 152.

As shown in FIG. 2, the reserve chamber R is formed by a concavity 2c in the engine block 2, which is open at surface 2a of the engine block, and by the part of the housing 101 that covers the concavity 2c. The reserve chamber R thus bounded in part by a wall 140, which is composed of a part 141 of the engine block 2 and a wall 142, which is a part of the housing 101. The entire wall that defines the reserve chamber is designated as wall 143.

The reserve chamber has a partition 145 that projects from part 140 and extends across the reserve chamber R as shown in FIG. 2. As shown in FIG. 4, the partition wall, a passage 160 is formed between the upper end 145a of wall 145 and an upper part 143u of the surrounding wall 143.

As shown in FIG. 4, the partition 145 divides the reserve chamber R into an entrance reserve chamber R1 into which the oil flows from the inlet 151, and a supply reserve chamber R2 from which oil flows through outlet 152. An upper space R3 is located above the entrance and supply reserve chambers R1 and R2 within which the two reserve chambers communicate through passage 160.

The entrance reserve chamber R1 is the part of chamber R below a first entrance oil level L1a which is a highest level, determined by the communication passage 160 at the upper end of partition wall 145. The supply reserve chamber R2 is a part of chamber R below a first supply oil level L2a, which is also determined by the communication passage 160. The upper space R3 is above oil levels L1a and L2a. The communication passage 160 is a part of the upper space R3, and is located above oil levels L1a and L2a.

The partition wall 145 prevents communication of oil from one chamber to the other at a level below the communication passage 160. The partition wall 145 is formed as a unitary part of the surrounding wall 143 in the embodiment shown, but in alternative embodiments, the partition wall can be formed separately from the surrounding wall 143.

The bottom wall 143b is a region of the surrounding wall 143 below a second entrance oil level L1b or a second supply oil level L2b. The upper wall 143u is a region of wall 143 above the first entrance oil level L1a and the first supply oil level L2a.

The communication passage 160 has an opening 161 to the entrance reserve chamber R1, and an opening 162 to the supply reserve chamber R2. Both openings 161 and 162 are located above the inlet 151 and above the outlet 152.

The inlet 151 is located above the lowest part R1b of the entrance reserve chamber R1 so that oil is reserved below the inlet 151 in the entrance reserve chamber. Therefore, the entrance reserve chamber R1 a volume Vi of oil remains in chamber R1 when the oil pump 20 is stopped.

When the engine 1 stops, oil leaks through a very small gap at the entrance oil passage C1. As shown in FIG. 4, after the supply of oil to the entrance reserve chamber R1 is stopped, the oil level in the entrance reserve chamber R1 drops to the second entrance oil level Lib, which determines the remaining volume Vi of oil in the entrance reserve chamber R1.

In the supply reserve chamber R2, the amount of oil available to the tensioner 100 through outlet 152, i.e., the supply reserve volume Vo, is the volume of oil between the first supply oil level L2a and the second supply oil level L2b, the second supply oil level being defined by the uppermost part of the outlet 152, as shown in FIG. 4.

If the engine is out of operation for a long time, there is a maximum amount of oil that can leak from the oil chamber 111 through a leakage path in the tensioner, e.g., the very small gap between the wall of the plunger-accommodating hole and the plunger. The time interval T and the term “long time interval,” as used herein, both refer to the time required for that maximum amount of oil to leak out of the oil chamber.

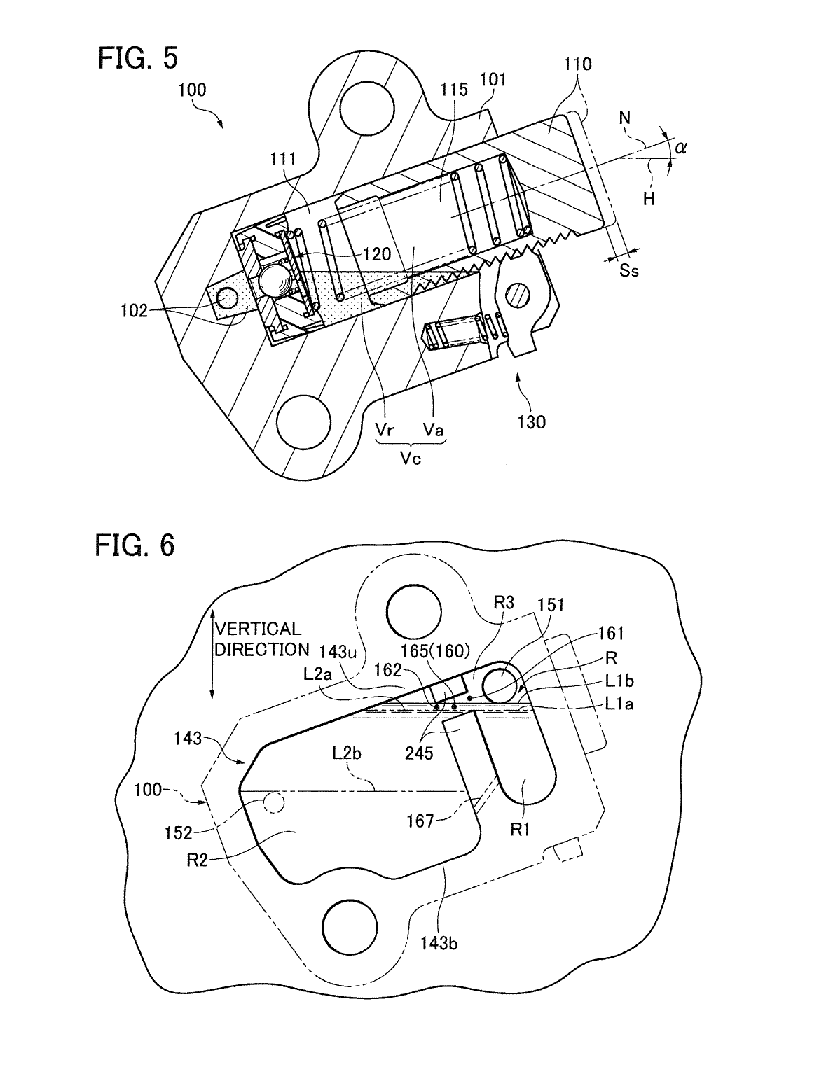

A reference volume Vc of the oil chamber 111 is a volume when the plunger is in a specific position between its most retracted position (indicated in FIGS. 2 and 3, which show an initial condition of the tensioner 100) and its most advanced condition. This specific position is a position (illustrated in FIG. 5) to which the plunger 110 advances from its most retracted position when a predetermined amount of wear elongation of the chain 16 occurs. This specific position of the plunger is closer to its most advanced position than to its most retracted position.

Volume Vr is the volume occupied by the oil remaining within the oil chamber 111 when a time T of non-operation of the engine (and of the engine oil pump) has elapsed. Volume Va is the calculated volume of air space 115 occupied by air within the oil chamber 111 having a reference volume Vc when the non-operation time T has elapsed.

The relationship between the reference volume Vc, the oil remaining oil volume Vr, and the calculated air space volume Va is:

Va=Vc−Vr

The volume of the oil chamber 111, i.e., the reference volume Vc, depends on a number of factors such as the inclination angle α, and can also be affected by the presence of a volume-reducing structure such as an internal column-shaped member disposed in the oil chamber 111.

The reference volume Vc is greater than the volume of the oil chamber 111 when the engine is inoperative for a long time T, until the plunger 110 reaches its specific position. In that case, the calculated air space volume Va is greater than the air space volume within the oil chamber 111 after the engine has been inoperative for a long time T.

The backlash of the tensioner 100 allowed by the ratchet mechanism 130 is a preset stroke Ss (FIG. 5) of the plunger on starting the engine.

The plunger 110 makes a plurality of reciprocating movements in the advancing and retracting direction due to fluctuations in the tension of the chain 16 on starting the engine after a long inoperative condition. Leakage of oil occurs as the plunger retracts during these reciprocating movements.

The minimum value A of the supply reserve volume Vo (FIG. 4) is preset in accordance with the following equation, based on the oil chamber remaining volume Vr, or the calculated air space volume Va (FIG. 5) and the starting leakage Qs of the oil:

A=Vc−Vr+Qs=Va+Qs=Va+Ns×Qu

where Ns is a number of times of the starting reciprocal movement, and Qu is starting unit leakage.

The unit starting leakage Qu is the amount of leakage of oil for one reciprocation of the plunger on starting the engine through a set stroke Ss.

The inoperative time T, the reference volume Vc, the oil chamber remaining volume Vr, the number Ns, and the unit starting leakage Qu are preset based on experiments or simulations.

The air space volume of the air space 115 and the set stroke amount Ss are set at values such that the check valve 120 opens due to a drop of pressure in the air space 115 as the plunger 110 advances by the set stroke Ss following a long inoperative condition of the engine .

More specifically, the calculated air space volume Va and the starting amount of change of volume Vs of the oil chamber 111 are set such that the rate R of change of volume of the air space 115, preset by the following equation, is more than a predetermined value:

R=Vs/Va

where, Vs, the starting amount of change of volume, is the amount of change of volume of the oil chamber 111 corresponding to the set stroke Ss.

The predetermined value of R is the minimum value of the rate R of change of volume of the air space when the check valve 120 is opened due to the drop of pressure of the air space 115 as the plunger 110 advances by the set stroke Ss.

Oil, supplied by oil pump 20, is introduced into the oil chamber 111 through the reserve chamber R. On starting the engine, however, an amount of oil corresponding to the advancing movement of the plunger 110 is supplied from the reserve chamber R to the oil chamber 111 before oil is supplied by the oil pump 20. Therefore, oil within the oil chamber 111, supplied from the reserve chamber R, suppresses flapping of the chain 16 on starting the engine, and reduces noise generated by the flapping.

When the tension in the chain increases after starting of the engine has been completed, pressure is applied to the oil within the oil chamber 111 by a reaction force exerted on the plunger of the tensioner by the chain 16. The application of pressure to the oil in oil chamber 111 cause oil to leak through the leakage gap of the tensioner, so that the oil exerts a damping function that reduces the speed of retraction of the plunger 110.

With this arrangement, the amount of oil that can be supplied from the supply reserve chamber R2 to the oil chamber 111 of the tensioner 100 after supply of oil to the reserve chamber R is stopped is determined based on the vertical positions of the communication passage 160 and the outlet 152. Therefore, even if air in the oil chamber 111 of the tensioner 100 infiltrates the supply reserve chamber R2 through the outlet 152 when the supply of oil to the reserve chamber R is stopped, the infiltrated air gathers in the upper space R3, where the communication passage 160 is located. Accordingly, the supply of oil is not affected by the infiltrated air.

When the pressure of the oil at inlet 151 drops after the supply of oil to the reserve chamber R stops, the drop in pressure will not cause a drop in the oil level in the supply reserve chamber R2. Since outlet 152 of the supply reserve chamber is located below the communication passage 160, a steady supply of oil from the supply reserve chamber R2 provided to the tensioner through passage 102. Accordingly, flapping of the chain on engine start-up is suppressed.

The inlet 151 is located above the lowest part of the entrance reserve chamber R1 so that oil is reserved below the inlet 151 in the entrance reserve chamber R1. With this arrangement, the supply the oil from the entrance reserve chamber R1 to the supply reserve chamber R2 through the communication passage 160 is reestablished rapidly, further ensuring that, in the operation of the tensioner, transient starting conditions are avoided.

The minimum value A of the supply reserved volume Vo of the oil in the supply reserve chamber R2 is preset based on the oil chamber remaining volume yr or the calculated air space volume Va and the starting leakage Qs of oil from the oil chamber 111 caused by the reciprocating movement of the plunger 110 on starting the engine 1 after the engine has been inoperative for a long time interval T.

The volume of the oil chamber 111 is smaller than the reference volume Vc before the plunger 110 reaches its specific position as illustrated in FIG. 5. Space 115, occupied by infiltrated air, is formed in the oil chamber 111 when the engine is inoperative for a long time. The volume of the air space 115 is an index of an insufficient amount of the oil within the oil chamber 111. The minimum amount of oil in the supply reserve chamber is sufficient to replenish the amount Qs of oil that leaks from the oil chamber 111 due to reciprocating movement of the plunger 110 caused by fluctuation of chain tension on starting the engine, and to replenish the amount of oil that corresponds to the air space volume Va calculated based on the reference volume Vc ,which is greater than the volume of the oil chamber 111 when the engine is an inoperative condition for a long time.

Accordingly, it is possible to shorten the starting transient of the tensioner and achieve improved suppression of flapping of the chain, while downsizing the supply reserve chamber R2.

The volume of the air space 115 within the oil chamber 111 when the engine is out of operation for a long time T is such that the check valve 120 is opened by a drop in pressure in the air space 115 when the plunger 110 advances by the preset stroke Ss on starting of the engine. Accordingly, oil in the supply reserve chamber R2 is fed efficiently to the oil chamber 111 through outlet 152, oil supply passage 102 and check valve 120, ensuring a short starting transient and effective suppression of chain flapping.

In an embodiment of the tensioner 100 not having the ratchet mechanism 130, preset stroke Ss is an advancing movement of the plunger 110 that corresponds to oscillation of the plunger due to flapping of the chain on engine start-up. A maximum value of this advancing movement can be determined by experiment or simulation.

In an alternative embodiment shown in FIG. 6, an inlet 151 can open to the upper space R3, and the partition wall can be a wall 245 having a part extending upward from bottom wall 143b, and another part extending downward from upper wall 143u, so that a slot or hole 165 in the partition wall constitutes the communication passage 160.

Parts in the embodiment shown in FIG. 6 that correspond to the embodiment shown in FIG. 4 are designated by the same reference numerals.

In the embodiment shown in FIG. 6, the second inlet oil level L1b is located above both oil levels L1a and L2a so that it is possible to increase the amount of oil that can be supplied to the tensioner upon engine start-up.

It is possible to increase the amount of oil that can be supplied to the tensioner on engine start-up even when an auxiliary oil passage 167, indicated by broken lines, is provided through the partition wall 245 at a location below the communication passage 160h.

In either of the embodiments described above, the reserve chamber R may be formed by a concave portion provided in the tensioner housing 101, a concave portion provided both in the tensioner housing 101 and the engine block 2, or a concave portion formed only in the engine block 2.

The partition wall 145 or 245 may extend from a part of the surrounding wall 143 other than the bottom wall 143b.

The specific position of the plunger may be an arbitrary position on either side of an intermediate position midway between the maximum advanced position of the plunger and its fully retracted position.

The tensioner 100 may also be mounted on the engine block 2 so that the axis of the plunger-accommodating hole, instead of being upwardly inclined as illustrated in FIGS. 1, 3, and 5, is horizontal or downwardly inclined when the automobile is on a horizontal roadway.

The engine in which the tensioner is used can be any driving unit that drives an endless flexible transmission medium, and can be a motor other than an internal combustion engine. The transmission medium to which a tension is applied can be a chain or an endless belt-like flexible member. The oil supply can be a pump or an accumulator. It is also possible to utilize the tensioner of the invention in an engine in which a valve closes to stop the supply of oil to the reserve chamber of the tensioner when the engine stops and opens to reestablish oil flow when the engine starts.

What is claimed is:

1. A tensioner for applying tension to an endless, flexible, traveling transmission medium driven by an engine, the tensioner comprising:
a housing adapted for attachment to an engine and provided with an oil supply passage and an plunger-accommodating hole;
a reserve chamber arranged to supply oil from an oil supply source to the oil supply passage when the engine is operating;
a plunger protruding from the plunger-accommodating hole of the housing and slidable therein in an advancing and retracting direction, said plunger and said housing forming an expansible oil chamber;
means for biasing a the plunger in said advancing direction; and
a check valve that permit oil to flow from the oil supply passage to the expansible oil chamber but limits reverse flow of oil from said expansible oil chamber to the oil supply passage;
wherein the reserve chamber is provided with an inlet for flow of oil from the oil supply source to the reserve chamber, and an outlet for flow of oil from the reserve chamber to said oil supply passage;
wherein the reserve chamber is divided by a partition wall into an entrance reserve chamber into which the oil flows from said inlet, and a supply reserve chamber from which oil flows through said outlet;
wherein the partition wall forms a communication passage for flow of oil from the entrance reserve chamber to the supply reserve chamber; and
wherein said communication passage is located above said outlet.

2. The hydraulic tensioner according to claim 1, wherein the partition wall establishes an oil level in said supply reserve chamber and an oil level in said entry reserve chamber, and prevents flow of oil from one of said reserve chambers to the other except through said communication passage.

3. The hydraulic tensioner according to claim 1, wherein said inlet is separated from, and located above, the lowest part of the entrance reserve chamber, whereby a quantity of oil is reserved below said inlet in the entrance reserve chamber.

4. The hydraulic tensioner according to claim 1, wherein the minimum value A of a supply reserved volume of oil in said reserve chamber is related to the volume occupied by oil remaining within the oil chamber after oil has not been supplied from said oil supply source for a long time interval, and to the amount of oil leakage from the oil chamber caused by reciprocating movement of said plunger on starting said engine after said long time interval, by the formula
A=Vc−yr+Qs
where:
Vc is a reference volume of the oil chamber larger than the volume of the oil chamber when said long time interval has elapsed;
Vr is the volume of oil remaining in said oil chamber when said long time interval has elapsed; and
Qs is the amount of the oil leakage from the oil chamber caused by the reciprocating movement of said plunger on starting said engine after the elapse of said time interval.

5. The hydraulic tensioner according to claim 1, wherein the volume of the air space within said oil chamber after oil has not been supplied from said oil supply source for a long time interval is such that said check valve is opened by a drop of pressure in said air space when the plunger advances by a predetermined starting stroke on starting the engine after the elapse said long time interval.
